(19) United States
(12) Patent Application Publication
(10) Pub. No.: US 2003/0028614 A1
(43) Pub. Date: Feb. 6, 2003

(54) Portable storage media and method of utilizing remote storage unit on network as auxiliary memory of local computer by using the same

(75) Inventor: Frank Jeon, Seoul (KR)

Correspondence Address: STAAS & HALSEY LLP, 700 11TH STREET, NW, SUITE 500, WASHINGTON, DC, 20001, US

(73) Assignee: NEXTER INFORMATION & TECHNOLOGY CO., LTD., Seoul (KR)

(21) Appl. No.: 09/941,579

(22) Filed: Aug. 30, 2001

(30) Foreign Application Priority Data
Aug. 2, 2001 (KR) 10-2001-46770

(51) Int. Cl. G06F 15/16

(52) U.S. Cl. 709/217

(57) ABSTRACT

A computer-readable portable storage medium that stores information to certify access to a remote computer and a program used to utilize a remote storage device managed by the remote computer. The program executes a procedure of being driven when the medium is mounted to the local computer, determining whether the local computer is connected to the network, reading a URL of the remote computer from the storage medium, connecting the local computer to the remote computer, reading and transmitting a certification key from the storage medium to the remote computer, and registering the remote storage device as an auxiliary memory of the local computer when access to the remote computer is allowed.

### CROSS-REFERENCE TO RELATED APPLICATIONS

This application claims the benefit of Korean Application No. 10-2001-46770, filed Aug. 2, 2001, in the Korean Industrial Property Office, the disclosure of which is incorporated herein by reference.

### BACKGROUND OF THE INVENTION

1. Field of the Invention

The present invention relates to a portable storage medium and a method of utilizing a remote storage unit on a network as an auxiliary memory of a local computer by using a portable storage medium.

2. Description of the Related Art

Due to the appearance of open-type networks such as the Internet, it is now possible to freely exchange information between a computer system in a local area and a computer system in a remote area. Particularly, computers now provide various information and programs to a plurality of computers, with the former being called a server computer, and the latter being called client computers. Heretofore, though not having specific software resource or hardware resource in his/her own computer, a user may use the above resources from the server computer at any time when the user computer is connected to the network.

Such an open-type communication network not only allows the user to access a desired resource at any time regardless of distance, but also gives an environment in which useful resources of on-line service providers can be distributed for free. For such a reason, the service providers who provide software or hardware resources through the Internet occasionally adopt a method of requesting a certification procedure to prevent unqualified access of users and allowing only the user, who has paid a certain amount of money, to access the resources. However, such a method has proved unsuccessful in enticing netizens to use the charged service since they are generally more familiar with using a free service.

Customers are generally accustomed to paying for a tangible article, but not accustomed to paying a proper price for an intangible product such as information or a program, particularly through the Internet. Therefore, there is a need to process the intangible product such as information, contents, data, program, etc., provided through an open-type network like Internet, so that the intangible product looks like a tangible product.

As an alternative, a storage medium such as a compact disk has been suggested. Customers generally do not resist buying a CD containing video and/or audio data or a CD containing a software program at a proper price. That is, the intangible information can be converted into a tangible product through a storage medium, CD. However, certain information or program cannot be stored in a limited area like on a CD. In other words, there exists information or programs that cannot be satisfactorily stored or distributed on a CD. Therefore, there is a need for alternatives to materialize the intangible product, such as on-line service, which cannot be distributed within the CD, into a portable storage medium.

To realize such a need, there have been various attempts, recently. For example, Korean Patent Publication No. 2001-39267 discloses a system and method for checking whether a computer is possibly accessing a network by using a compact disk storing certification information, which is input with an encrypting technique. However, this method simply includes the certification information in the compact disk and is therefore not much different from a conventional charged site, which requests logging-in on-line.

In addition, Korean Patent Publication No. 2001-25575 discloses a method of accessing required information on-line/off-line when a portable storage medium, which contains programs for off-line information management and on-line networking, is inserted to a client computer. However, such a method is no different from other conventional charged on-line service, except that the logging-in process is executed in the client computer by setting a separate interface in the computer. That is, the on-line networking program is not for changing an existing free service to a charged service, but is no more than adding the logging-in process to overcome a limit of an off-line program.

Therefore, there is still needed a method with which the computer having the portable storage medium may naturally enjoy the on-line service at a local area as if the on-line service from a server computer on network is written in the portable storage medium. More recently, there is provided an on-line service that ensures a specific storage area at a remote storage device on network, and then allows users to access a storage area through Internet for usage of the storage device. However, because the storage area is commonly accessible with a proper price, the user rarely recognizes the storage area as a tangible product, which should be paid.

### SUMMARY OF THE INVENTION

To overcome the above and other disadvantages and drawbacks, it is an object of the invention to provide a method of allowing a user at a local computer to use a remote storage device through a network at a proper price.

It is another object of the present invention to allow a user to use a remote storage device as if it is an auxiliary memory of a local computer by using a portable storage medium such as a compact disk.

Additional objects and advantages of the invention will be set forth in part in the description which follows and, in part, will be obvious from the description, or may be learned by practice of the invention.

In order to accomplish the above and other objects, a computer-readable portable storage medium that stores information used to certify access to a remote computer from a local computer in which the storage medium is mounted and a program used to utilize a remote storage device, managed by the remote computer, as a virtual auxiliary memory of the local computer, the program is a computer-readable client program that executes the procedures according to the present invention of being driven as soon as the portable storage medium is mounted to the local computer, determining whether the local computer is connected to a network, reading location information of the remote computer from the storage medium and then connecting the local computer to the remote computer when the local computer is connected to a network reading certification information from the storage medium and transmitting the certification information to the remote computer, and registering the remote storage device as an auxiliary memory of the local computer when access to the remote computer is allowed.

According to another embodiment of the present invention, the registering the remote storage device includes setting a drive to operate the remote storage device in the local computer, and designating an identifier for the drive on a searching interface of the local computer.

According to yet another embodiment of the present invention, the program further includes executing the procedure of automatically connecting the local computer to the network when the local computer is not connected to the network.

According to still another embodiment of the present invention, the certification information defines an address to designate a specific storage area of the remote storage device.

According to yet still another embodiment of the present invention, the identifier is selected among identifiers that are currently not used in the local computer.

According to a further embodiment of the present invention, the portable storage medium is a mini compact disk.

According to a yet further embodiment of the present invention, a method of utilizing a remote storage device on a network as a virtual auxiliary memory of a local computer by using a portable storage medium storing certification information and a computer-readable program according to an embodiment of the present invention includes inserting the portable storage medium into a corresponding drive of the local computer, driving the program, checking with the program whether the local computer is connected to the network, connecting the local computer to a remote computer, which manages the remote storage device, when the local computer is connected to the network, reading the certification information from the storage medium and transmitting the certification information to the remote computer, allowing access of the local computer to the remote storage device on the basis of the certification information, and registering the remote storage device as an auxiliary memory of the local computer.

According to a still further embodiment of the present invention, the remote storage device has a plurality of storage areas, each of which corresponds to corresponding certification information.

According to a yet still further another embodiment of the present invention, the method further includes, when the access to the remote storage device is allowed, setting a drive for operating the remote storage device in the local computer, and designating an identifier for the drive on a searching interface of the local computer.

According to an additional embodiment of the present invention, if the local computer is in connection to the remote storage device, it becomes possible to either download data from the remote storage device to the local computer or upload data from the local computer to the remote storage device.

According to a yet additional embodiment of the present invention, when receiving the certification information, the remote computer determines whether there is a storage area corresponding to the certification information in the remote storage device, determine whether a storage capacity remains in the storage area and whether a valid term is not expired, when the corresponding storage area exists, and allows access to the remote storage device when the storage capacity remains and the valid term is not expired.

According to a still additional embodiment of the present invention, a method on a network according to the present invention includes storing a computer-readable program in a portable storage medium, allowing a user to insert the portable storage medium into a local computer, the local computer communicating with a remote computer via the network by using the computer-readable program, wherein the remote computer includes a remote storage device, and operating the remote storage device as a virtual auxiliary memory of the local computer by using the computer-readable program.

### BRIEF DESCRIPTION OF THE DRAWINGS

These and other features, aspects, and advantages of the present invention will become better understood and more readily appreciated with regard to the following description of the preferred embodiments and the accompanying drawings, in which like components are referred to by like reference numerals. In the drawings:

FIG. 1 shows a configuration of a system for implementing the process of accessing a remote storage device according to an embodiment of the present invention;

FIG. 2 shows a configuration of a compact disk according to an embodiment of the present invention;

FIG. 3 is a table showing a data structure of a certification key database according to an embodiment of the present invention;

FIG. 4 is a flow chart for illustrating the process of manufacturing the compact disk according to an embodiment of the present invention;

FIGS. 5 and 6 are flow charts for illustrating the process of accessing the remote storage device by using the compact disk according to an embodiment of the present invention; and

FIG. 7 shows a remote drive being accessed according to an embodiment of the present invention.

### DETAILED DESCRIPTION OF THE PREFERRED EMBODIMENTS

Reference will now be made in detail to the present preferred embodiments of the present invention, examples of which are illustrated in the accompanying drawings, wherein like reference numerals refer to the like elements throughout. The embodiments are described below in order to explain the present invention by referring to the figures.

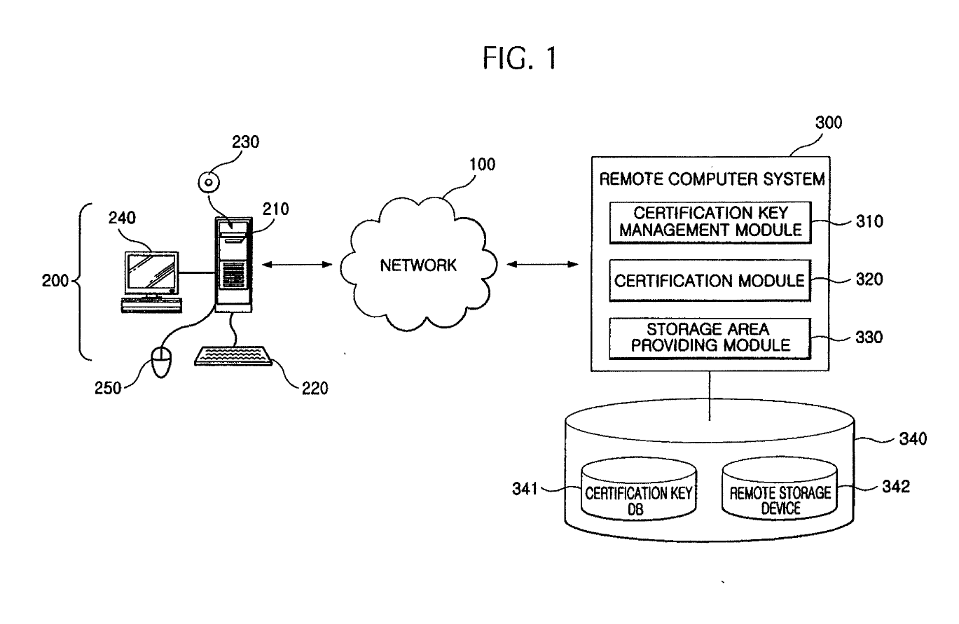

FIG. 1 shows a configuration of a system for implementing a method according to an embodiment of the present invention. As shown in FIG. 1, the system includes a remote computer system 300 and a local computer system 200, both of which are mutually connected through a network 100.

The local computer system 200 is an information terminal, which has a communication device for accessing the network 100, and a drive for driving auxiliary memories such as a floppy disk and compact disk 230. Such an information terminal 200 includes, as peripherals, input devices such as a keyboard 220 and a mouse 250, a terminal main body 210 that executes data processing in response to an input signal, and a monitor 240 to visually display the data processing status. In addition, the terminal main body 210 also includes a CPU (Central Processing Unit) for overall control, a ROM (Read-Only Memory) having a minimum amount of programs to read out information or programs from the auxiliary memories like CD-ROM, a memory to store the programs or processed results, a system bus for interlinking among such parts, and other similar devices normally associated with general and/or special purpose computers.

As a local computer system 200, it is preferred to use a laptop computer or a hand-held computer. However, it is understood that all information communication terminals can be used as the local computer 100 if they can accomplish the objects of the present invention by receiving a storage medium from outside and exchanging data with the remote computer on network.

The term “local computer” 200 has a meaning contrary to the remote computer 300 and designates all information communication terminals that guide a user to access program, contents, hardware, etc. in the remote computer 300. In other words, an information terminal that is directly used by the user is designated as a local computer 200, while an information terminal that provides software such as program or contents and hardware such as a storage device 342 to the user is designated as a remote computer 300.

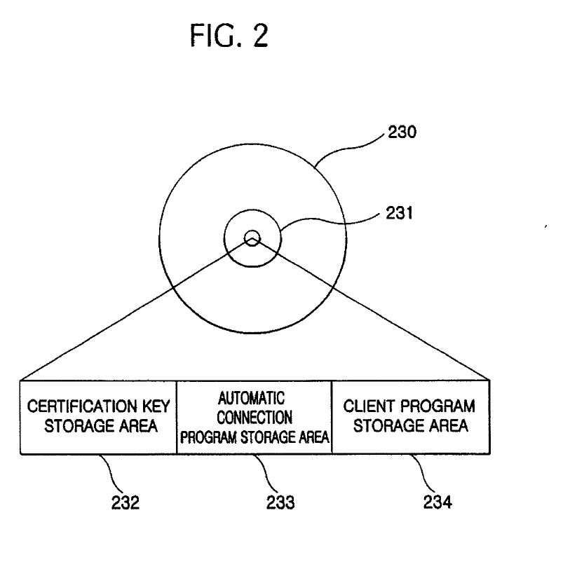

A portable storage medium 230 is removably mounted in the local computer 200. As a storage medium 230, a compact disk as shown in FIG. 2 is preferably used. More preferably, the storage medium is a mini disk (MD) having a diameter less than 64 mm so as to be hung around the neck with a string like a necklace or easily carried. The mini disk can also be made in a rectangular type instead of a circular type. While a compact disk is exemplarily employed as the portable storage medium, it is understood that the portable storage medium of the present invention can be other storage media such as floppy disk, portable hard disk, smart card and so on.

As shown in FIG. 2, the portable storage medium 230, for example a compact disk, of the present invention includes a certification key storage area 232, an automatic connection program storage area 233, and a client program storage area 234. In the certification key storage area 232, information used for certifying access (or right to access) to the remote computer system 300 is written. The certification information is provided from the remote computer system 300. In addition, a certification key corresponding to the certification information is stored in a certification key database 341 of the remote computer system.

The automatic connection program stored in the corresponding area 233 plays a role of automatically connecting the local computer 200 to the network 100 when the local computer 200 having the storage medium 230 is not connected with the network 100.

The client program stored in the corresponding area 234 is executed as soon as the storage medium 230 is mounted to the local computer 200. The client program checks whether the local computer 200 is connected with the network 100. If the local computer 200 is not connected with the network 100, the client program executes the automatic connection program. After the local computer 200 is connected to the remote computer 300, the client program reads out the certification key from the corresponding area 232 and then transmits the key to the remote computer 300.

The client program also includes an application program to support the local computer 200 in using various resources, particularly hardware resources (e.g. storage device), in the remote computer 300.

It is understood that the portable storage medium 230 of the present invention may also include other data and programs than the above-described information and program shown in FIG. 2.

The remote computer system 300 is a computer to manage the storage medium and a remote storage device 342. As shown in FIG. 1, the remote computer system 300 includes program modules such as a certification key management module 310, a certification module 320, and a storage area providing module 330. The remote computer system 300 also includes storage devices such as a certification key database 341 and the remote storage area 342.

The remote computer system 300, namely a disk management server, can deal with a large amount of tasks by executing an enormous amount of mathematical calculation during information processing or database searching. Preferably, a Pentium® Microprocessor produced by Intel® is used as the CPU for the server, but it is understood that other CPUs are available for use.

Hereinafter, functions of the disk management server 300 are explained in detail with reference to FIG. 1. The certification key management module 310 of the disk management sever 300 generates a certification key to be written in the storage medium 230 and stores information such as storage capacity or valid term of the remote storage device 342 corresponding to the certification key in the certification key database 341, described below. In addition, the certification key management module 310 updates and manages the storage capacity and valid term information of the remote storage device 342 for each certification key, which is stored in the certification key database 341, whenever necessary.

When receiving a certification key from the local computer 200, the certification module 320 determines whether the received certification key exists in the certification key database 341. If the received certification key exists in the database 341, the certification module 320 allows access of the local computer 200, and prevents access if the received certification does not exist in the database 341.

If the certification module 320 allows access of the local computer 200, the storage area providing module 330 extracts an address of the remote storage device (or, remote storage area) 342 on the basis of the certification key. The storage area providing module 330 then provides the storage area corresponding to the address to the local computer 200 as a virtual auxiliary memory. Therefore, only by inserting the storage medium 230 into the local computer 230, the user may download data from the remote storage device 342 to the local computer 200 or upload data from the local computer 200 to the remote storage device 342.

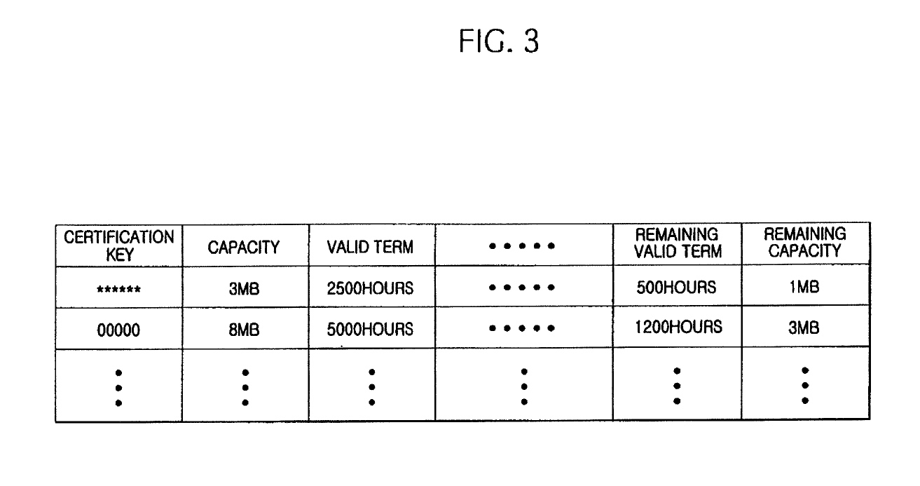

The certification key database 341 of the database system 340 has a data configuration as shown in FIG. 3. In other words, the certification key database 341 stores various data or information related to a certification key, such as allowed storage capacity, valid term, corresponding address, remaining valid term, remaining storage capacity, etc.

The remote storage device 342 includes a plurality of storage areas, each of which is allocated to a corresponding certification key. Each storage area stores data or files uploaded by the corresponding user.

The network 100 connecting the local computer 200 and the remote computer 300 is preferably a wire/wireless Internet. However, it is understood that the network could be understood to include all of Intranet, Extranet, LAN (Local Area Network), WAN (Wide Area Network) and Leased line.

Now, the method of the present invention is described in detail on the basis of the above-described system configuration.

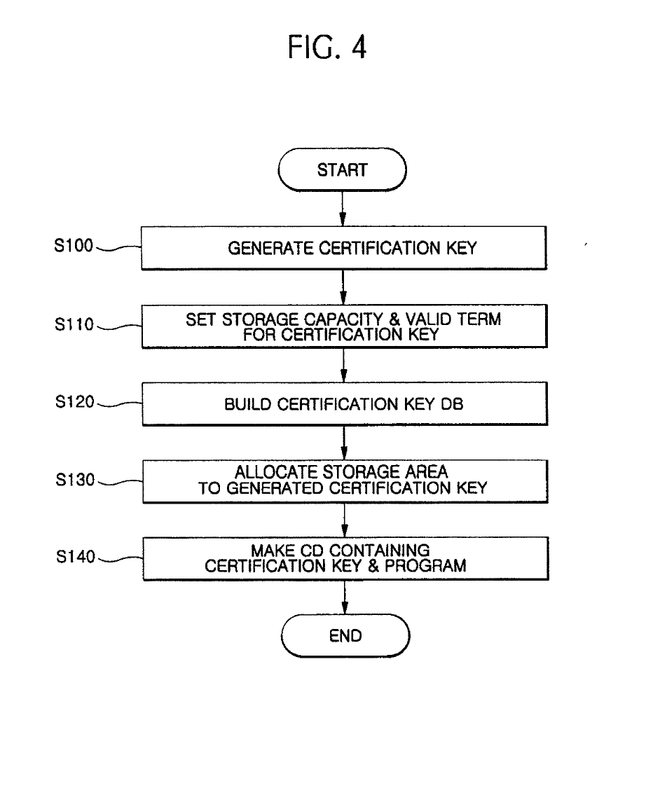

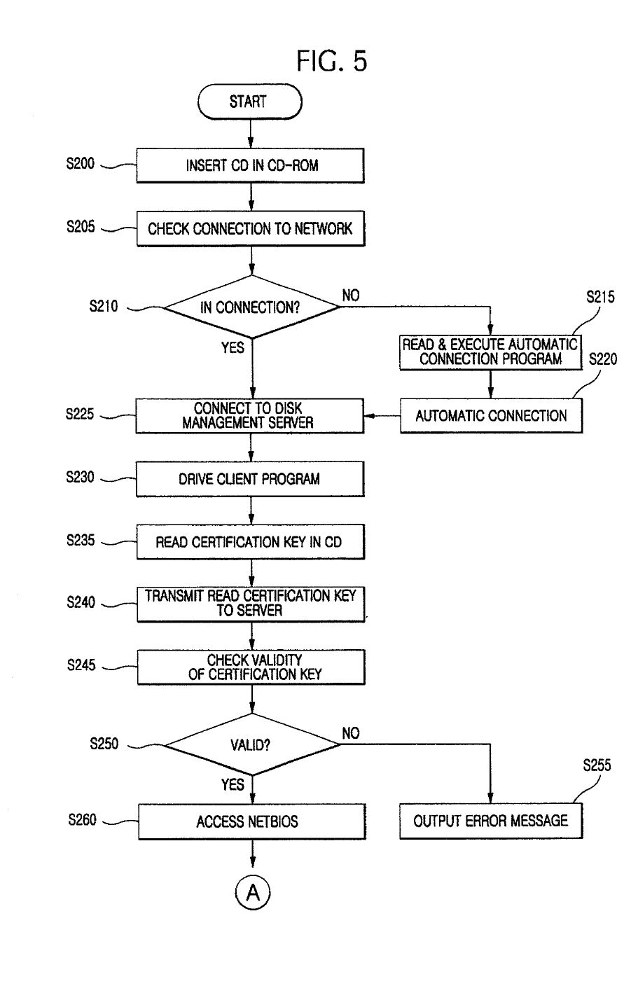

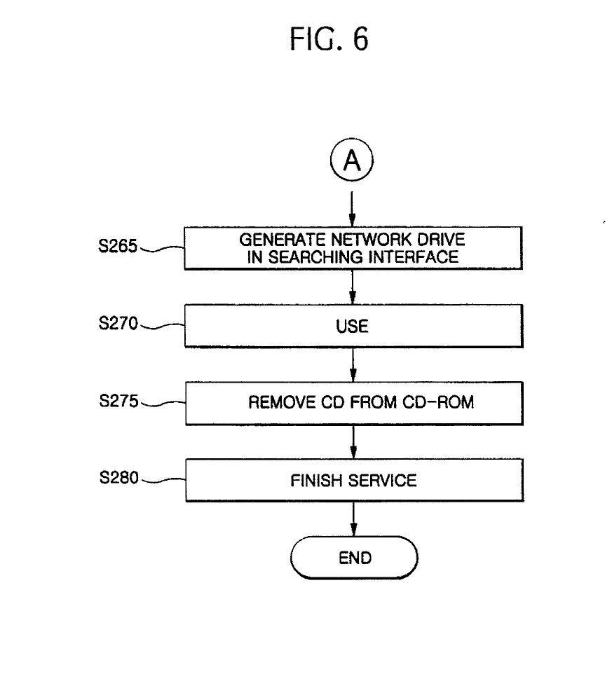

First, a process of manufacturing the portable storage medium according to the present invention is shown in FIG. 4. A service provider, who wants to provide remote storage areas to unspecified potential users through the remote computer system 300, generates a certification key at random (S100), and sets a storage capacity and a valid term for the certification key (S110). After generating the certification key and determining the storage capacity and the valid time for the certification key, the certification key database 341 is built or updated with the above information in the remote computer 300, as shown in FIG. 3 (S120). Then, a storage area corresponding to each certification key is allocated in the data storage device, which will be used as a remote storage device by a user (S130). If the creation of certification key and the allocation of storage area are complete, the service provider makes the portable storage medium (e.g. compact disk) 230 as shown in FIG. 2, for each certification key. At this time, the compact disk 230 should contain the certification key generated in the operation S100, the automatic connection program and the client program (S140).

After manufacturing the compact disk 230 containing the certification key and the programs, the service provider sells the compact disk 230 with a proper price through an on-line and/or off-line sales network. At this time, on an outer side of the compact disk 230, the valid term and the storage capacity are printed, which makes the consumers to consider the compact disk 230 as a storage medium containing the printed storage capacity. For example, if “Storage Capacity 30 GB” is printed on the outer side of the compact disk 230, the consumers recognize that the compact disk has the storage capacity of 30 GB. Therefore, the customers will not have resistance to buying the storage medium 230 because they recognize the storage medium 230 as if it is an existing mass storage hard disk.

The user, who has purchased the compact disk 230 (hereinafter, abbreviated as CD), inserts the CD 230 into a CD-ROM drive of his/her own or other specific computer (hereinafter, referred to local computer 400) in order to use the mass capacity storage device (S200).

If the CD 230 is inserted into the CD-ROM drive, the program in the CD 230 searches network circumstance of the local computer 200 to check whether the local computer 200 is connected with the network 100 (S205). If the local computer 100 is not connected with the network 100 (NO branch in the step S210), the automatic connection program is called out from the CD 230 (S215).

The automatic connection program called out to the local computer 200 then automatically connects the local computer 200 to the network 100 using relevant network connection tools in the local computer 200 (S220).

If the local computer 200 is already connected to the network 100 in the step S210 (YES branch), or after connecting the local computer 200 to the network 100 through the operations S215-S220, location information of the remote computer 300 (or, IP address) is read out from the CD 230 and the local computer 200 is then connected to the remote computer 300 (or, disk management server) on the basis of the location information (S225). If the local computer 200 is connected to the remote computer 300, the client program in the CD 230 is driven according to Auto-Run process (S230). At this time, it is preferred that the client program is not installed in the local computer 200 to be resident therein.

The client program, which is driven with Auto-Run function, then reads the certification key from the certification key storage area 232 of the CD 230 (S235), and transmits the certification key to the remote computer system 300 (S240).

The certification module 320 of the remote computer 300, which receives the certification key from the local computer 200, checks whether the received certification key exists in the certification key database 341. In other words, the certification module 320 checks whether the received certification key is valid (S245).

The validity checking process for the certification key is now described in more detail. If the certification key is checked and found to exist in the corresponding database 341, the certification module 320 checks the remaining storage capacity and the remaining valid term for the certification key. At this time, if there is no remaining storage capacity or the valid term has expired, the certification module 320 does not allow the user access and sends a message requesting the user to purchase another new portable storage medium 230 or charges additional amount of money to update the existing storage medium. On the other hand, if there is remaining storage capacity and the valid term is not expired, the certification module 320 allows to user to access the remote storage device 230. However, if the received certification key does not exist in the corresponding database 341 or is proved invalid (NO branch in the step S250), an error message is output to the local computer and the service is quitted (S255).

If the received certification key is valid in the step S250 (namely, if the received certification key exists in the corresponding database and there are the remaining storage capacity and the remaining valid term), the local computer 200 accesses NetBios (S260).

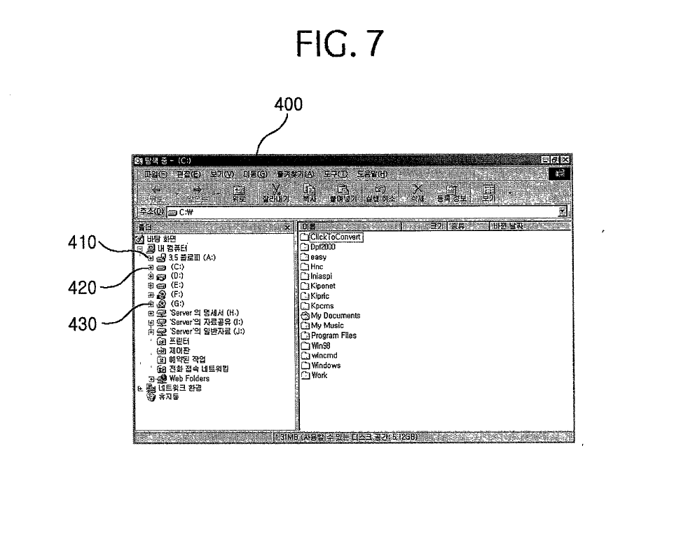

As described above, with the access to the remote storage device 342 allowed, the client program in the CD 230 sets a separate drive in the local computer 200 to operate the remote storage device 342 so that the local computer 200 may access the designated storage area. If the drive of the remote storage device is set in the local computer 200, a specific identifier 430 corresponding to the drive is generated in a storage device searching interface 400 such as Windows® Explorer of the local computer (S265), as shown in FIG. 7.

In FIG. 7, “(A:)” indicated by a reference number 410 is an identifier for a floppy disk drive, “(C:)” indicated by a reference number 420 is an identifier for a hard disk, and “(G:)” indicated by a reference number 430 is the identifier for the drive of the remote storage device 312. Though the remote storage device 342 drive is designated with “(G:)”, the identifier of the drive for the remote storage device is not limited to that case shown in the figure, but can be selected among identifiers that are currently not used by the local computer 200.

Accordingly, the local computer 200 recognizes the remote storage device 342 as if it is a new auxiliary memory and the user perceives that the compact disk 230 possesses a mass storage area corresponding to the storage area of the remote storage device 342.

Once the identifier of the drive for operating the remote storage device 342 is designated in the searching interface 400, the user can either download data from the corresponding storage area of the remote storage device to the local computer 200 or upload data from the main memory or other auxiliary memories of the local computer 200 to the remote storage device 342 (S270).

Therefore, the user may possess the storage area having a size secured by the remote computer 300 only by purchasing the portable storage medium 230 and inserting it into the local computer 200.

On the other hand, if the user removes the CD 230 from the CD-ROM drive of the local computer 200 (S275), the drive for the remote storage device 342 and its identifier are automatically deleted from the local computer 200 and all services provided with the CD 230 are finished without remaining any related program or information in the local computer 230 (S280). In other words, the information or program in the CD 230 is not resident permanently in the local computer 200.

According to the present invention, the user may possess a mass storage area in his/her own computer by purchasing the portable storage medium, which allows access to the mass storage device prepared on network.

In addition, the present invention may minimize reluctance of users in changing an existing free on-line storage area providing service to a charged one.

The portable storage medium and the method of utilizing a remote storage unit on network as an auxiliary memory of a local computer by using the portable storage medium according to the present invention have been described in detail. However, it should be understood that the detailed description and specific examples, while indicating preferred embodiments of the invention, are given by way of illustration only, since various changes and modifications within the spirit and scope of the invention will become apparent to those skilled in the art from this detailed description, the scope of which is defined in the claims and their equivalents.

What is claimed is:

1. A portable storage medium, which is readable with a computer, wherein the portable storage medium stores:
information used to certify access to a remote computer from a local computer in which the storage medium is mounted; and
a program used to utilize a remote storage device, managed by the remote computer, as a virtual auxiliary memory of the local computer, said program being a computer-readable client program that executes the procedures of:
being driven as soon as the portable storage medium is mounted to the local computer;
determining whether the local computer is connected to a network;
reading location information of the remote computer from the storage medium and then connecting the local computer to the remote computer when the local computer is connected to the network;
reading said certification information from the storage medium and transmitting said certification information to the remote computer; and
registering the remote storage device as an auxiliary memory of the local computer when access to the remote computer is allowed.

2. The portable storage medium as claimed in claim 1, wherein said registering the remote storage device includes:
setting a drive to operate the remote storage device in the local computer; and
designating an identifier for the drive on a searching interface of the local computer.

3. The portable storage medium as claimed in claim 1, wherein said program further automatically connects the local computer to the network when the local computer is not connected to the network.

4. The portable storage medium as claimed in claim 2, wherein the certification information defines an address to designate a specific storage area of the remote storage device.

5. The portable storage medium as claimed in claim 4, wherein the identifier is selected among identifiers that are currently not used by the local computer.

6. The portable storage medium as any of claim 1, wherein the portable storage medium is a mini compact disk.

7. A method of utilizing a remote storage device on a network as a virtual auxiliary memory of a local computer using a portable storage medium storing certification information and a computer-readable program, the method comprising:
inserting the portable storage medium into a corresponding drive of the local computer;
driving the program;
checking with the program whether the local computer is connected to the network;
connecting the local computer to a remote computer, which manages the remote storage device, when the local computer is connected to the network;
reading the certification information from the storage medium and transmitting the certification information to the remote computer;
allowing access of the local computer to the remote storage device on the basis of the certification information; and
registering the remote storage device as an auxiliary memory of the local computer.

8. The method as claimed in claim 7, wherein the certification information defines an address to designate a specific storage area of the remote storage device.

9. The method as claimed in claim 8, wherein the remote storage device comprises a plurality of storage areas, each of which corresponds to certification information of portable storage media including the portable storage medium.

10. The method as claimed in claim 9, further comprising:
when the access to the remote storage device is allowed on the basis of the certification information,
setting a drive to operate the remote storage device in the local computer; and
designating an identifier for the drive on a searching interface of the local computer.

11. The method as claimed in claim 10, further comprising downloading data from the remote storage device to the local computer or uploading data from the local computer to the remote storage device.

12. The method as claimed in claim 7, further comprising:
in the remote computer which receives the certification information,
determining whether there is a storage area corresponding to the certification information in the remote storage device;
determining whether a storage capacity remains in the storage area and whether a valid term is not expired, when the corresponding storage area exists; and
allowing access to the remote storage device when the storage capacity remains and the valid term is not expired.

13. The method as claimed in claim 7, further comprising automatically connecting the local computer to the network when the local computer is determined to not be connected to the network by said checking with the program.

14. A method on a network, comprising:
storing a computer-readable program in a portable storage medium;
allowing a user to insert the portable storage medium into a local computer; and
using the computer-readable program,
having the local computer communicate with a remote computer through the network, wherein the remote computer comprises a remote storage device, and
operating the remote storage device as a virtual auxiliary memory of the local computer.

15. The portable storage medium as any of claim 2, wherein the portable storage medium is a mini compact disk.

16. The portable storage medium as any of claim 3, wherein the portable storage medium is a mini compact disk.

17. The portable storage medium as any of claim 4, wherein the portable storage medium is a mini compact disk.

18. The portable storage medium as any of claim 5, wherein the portable storage medium is a mini compact disk.
